(19) United States
(12) Patent Application Publication
(10) Pub. No.: US 2010/0061430 A1
(43) Pub. Date: Mar. 11, 2010

(54) Transmission/Reception Device

(75) Inventor: Etsuji NAKAGIRI, Kawasaki (JP)

Correspondence Address: HANIFY & KING PROFESSIONAL CORPORATION, 1055 Thomas Jefferson Street, NW, Suite 400, WASHINGTON, DC, 20007, US

(73) Assignee: FUJITSU LIMITED, Kawasaki-shi (JP)

(21) Appl. No.: 12/621,172

(22) Filed: Nov. 18, 2009

Related U.S. Application Data
(63) Continuation of application No. PCT/JP2007/000684, filed on Jun. 25, 2007.

(51) Int. Cl. H04B 1/38; H04L 27/28

(52) U.S. Cl. 375/219; 375/260

(57) ABSTRACT

For transmission, a modulation method with a high bit rate is applied to subchannels with good transmission path characteristics, and a modulation method with a low bit rate is applied to subchannels with poor transmission path characteristics. In doing this, transmission path characteristic detection units 19 and 29 detect information on transmission path characteristics from received signals, and maximum bit-rate calculation units 20 and 30 use a minimization algorithm of a matroid convex function in order to determine a combination of values of transmission power for each of the subchannels that results in the maximum bit rate of the entire band. A combination of the determined transmission power and the modulation method (bit rate) is used for transmitting signals.

### CROSS REFERENCE TO RELATED APPLICATION

This application is a continuation of the PCT application PCT/JP2007/000684, filed on Jun. 25, 2007, entire contents of which are hereby incorporated by reference.

### FIELD

The embodiments discussed herein are related to a transmission/reception device that uses a multicarrier communications method such as orthogonal frequency division multiplexing (including OFDM and OFDMA alike) or the like. The present invention is particularly suitable for maximizing bit rates.

### BACKGROUND

OFDM (Orthogonal Frequency Division Multiplexing) and OFDMA (Orthogonal Frequency Division Multiple Access) have already been used in fields of digital terrestrial television and WiMAX, and are also planned to be adopted for 3.9/4th generation cell-phone systems. OFDM(A) is a communications method by which many users can select modulation methods adaptively to external radio environments for a band including many subcarriers and many symbols. According to non-Patent Documents 1 and 2, etc., bit numbers of modulation methods, which are inherently discrete values, are changed to successive variables and the optimal bit allocation problem is extended to the successive value convex optimization problem. A maximization algorithm for convex successive functions can be realized by a “water-filling algorithm” disclosed, for example, by non-Patent Documents 1 and 2. This method is used for maximizing bit rates.

Generally, if a rate function is a convex continuous function, a “water-filling algorithm” can be applied. However, resultant solutions are rounded to a nearest integer so that a suboptimal solution is obtained, and this prevents obtainment of a proper optimal solution, which is problematic. A “water-filling” algorithm is an algorithm for obtaining the optimal value of continuous functions. In the case of discrete functions, a “greedy algorithm” can be applied generally. However, in such a case, calculations have to be performed for M^{N} cases, drastically increasing the calculation amount and making this algorithm unpractical, which is problematic. Also, a “greedy algorithm” is an algorithm for obtaining the optimal value of a discrete function, but it requires an immense number of calculations, making itself unpractical for actual calculations.

Non-Patent Document 1: “Bit-Rate Maximization for Multiuser OFDM Systems” by Tase (NTT WEST), Ohno (Hiroshima University), and Hinamoto (Hiroshima University) published by The Institute of Electronics, Information and Communication Engineers as A Vol. J88-A No. 3, pp. 364-372.

Non-Patent Document 2: “An Efficient Waterfilling Algorithm for Multiple Access OFDM” by Gehard Munz, Stephan Pfleschinger, and Joachim Speidel in IEEE Global Telecommunications Conference 2002 (Globecom' 02), Taipei, Taiwan, November 2002

### SUMMARY

An aspect of the present invention is a transmission/reception device that is for a communications system using a plurality of subcarriers and that is able to set transmission power and a modulation method for each of the subcarriers, including: a transmission path characteristic extraction unit for extracting a transmission path characteristic from a received signal, a maximum bit-rate determination unit for determining a transmission power value and a transmission bit rate of each subcarrier by using a minimization algorithm of a discrete function for minimizing a function expressing a relationship between a discrete transmission power value and a bit rate, on the basis of a transmission path characteristic, so that a bit rate of an entire transmission is maximized, and a transmission unit for transmitting a signal by using a modulation method corresponding to the determined transmission power value and the determined transmission bit rate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed

### BRIEF DESCRIPTION OF DRAWINGS

FIG. 1 is a conceptual diagram of a configuration for OFDM communications;

FIG. 2 is a flowchart for an optimal bit rate calculation algorithm according to embodiments of the present invention;

FIG. 3 illustrates effects of embodiments of the present invention; and

FIG. 4 is a block diagram of a transmission/reception device according to embodiments of the present invention.

### DESCRIPTION OF EMBODIMENTS

### (1.1) Formulation of Bit Rate

In OFDM(A) communications methods, data is divided into data blocks, and plural subcarriers that are orthogonal to each other are used for each of the blocks in order to perform transmission. In a communications method in the present invention, modulation methods can be changed separately and adaptively to the states of transmission paths. Specifically, more bits or less power is allocated to subcarriers under good transmission path conditions, and fewer bits or more power is allocated to subcarriers under a poor transmission path condition so that the entire performance of a system improves.

Here, the number of subcarriers of OFDM(A) is assumed to be N, and one OFDM(A) symbol is handled. Also, the total number of users is assumed to be M. If a signal transmitted to the m-th (1≦m≦M) user of the n-th (0≦n≦N−1) subcarrier is u_{m,n} and a frequency response in the frequency of 2πn/N of the transmission path of the m-th user is H_{m,n}, reception signal r_{m,n} of the m-th user in the n-th subcarrier is expressed by the expression below:

$$\begin{matrix}[ Expression 1 ] & \\ \begin{matrix}{r}_{m , n} = {H}_{m , n} \cdot {\sum }_{μ = 1}^{M} {u}_{μ , n} + {v}_{m , n} \\ = {H}_{m , n} \cdot {u}_{m , n} + {H}_{m , n} \cdot {\sum }_{μ = 1 , μ \neq m}^{M} {u}_{μ , n} + {v}_{m , n}\end{matrix} & ( 1 )\end{matrix}$$

where the first term on the right side is a desired signal, and the second term is the interference from other users using the same subcarrier, ν_{m,n} is complex Gaussian noise whose mean is 0, and variance is σ²_{m,n}.

Next, the signal power to the m-th user in the n-th subcarrier is assumed to be:

p_{m,n}≡E{|u_{m,n}|²} [Expression 2]

where E{•} is an expected value. In accordance with expression (1), the CINR (Carrier to Interference Noise Ratio) in the n-th subcarrier used by the m-th user is expressed by the expression below.

$$\begin{matrix}[ Expression 3 ] & \\ {CINR}_{m , n} = \frac{{\vert {H}_{m , n} \vert}^{2} \cdot {p}_{m , n}}{{σ}_{m , n}^{2} + {\vert {H}_{m , n} \vert}^{2} \cdot {\sum }_{μ = 1 , μ \neq m}^{M} {p}_{μ , n}} & ( 2 )\end{matrix}$$

Communication performance is expressed in units of rates, and a function that expresses a rate is referred to as a rate function. Generally, a rate function can be assumed to be a function that is convex upwardly with respect to a Carrier to Interference Noise Ratio (CINR). Assuming that a rate function is f(•), the rate to the m-th user is expressed in the form of the sum of the rates of all subcarriers, which is expressed by the expression below:

$$\begin{matrix}[ Expression 4 ] & \\ {\sum }_{n = 0}^{N - 1} f ( {CINR}_{m , n} ) & \end{matrix}$$

and the sum of the rates to all users are expressed by the expression below.

$$\begin{matrix}[ Expression 5 ] & \\ R ≡ {\sum }_{m = 1}^{M} {\sum }_{n = 0}^{N - 1} f ( {CINR}_{m , n} ) & ( 3 )\end{matrix}$$

It is desirable that more bits be allocated to subcarriers with good CINRs of transmission path conditions, and fewer bits be allocated to subcarriers with poor CINRs of transmission path conditions. The relationships between modulation methods and bit numbers are expressed in integer form, as below.

### BPSK=1 bit

QPSK=2 bits
8-QAM=3 bits
16-QAM=4 bits
64-QAM=5 bits

Accordingly, the rate function is expressed by the expression below, taking into consideration that rate functions result in positive integers only.

$$\begin{matrix}[ Expression 6 ] & \\ {R}_{b} ≡ {\sum }_{m = 1}^{M} {\sum }_{n = 0}^{N - 1} {f}_{b} ( {CINR}_{m , n} ) & ( 4 )\end{matrix}$$

### (1.2) Transmission Power Condition

When the total transmission power maximum value of an access point is assumed to be P, the expression below has to be satisfied.

$$\begin{matrix}[ Expression 7 ] & \\ {\sum }_{m = 1}^{M} {\sum }_{n = 0}^{N - 1} {p}_{m , n} \leq P & ( 5 )\end{matrix}$$

The expression resulting in the maximum rate sum (4) with {p_{m,n}}m=1, . . . , M, n=0, . . . , N−1 that satisfies the transmission power condition (5) is as below. Because f_{b}() is an increasing function,

$$\begin{matrix}[ Expression 8 ] & \\ {R}_{b} \leq {\sum }_{m = 1}^{M} {\sum }_{n = 0}^{N - 1} {f}_{b} ( \frac{{\vert {H}_{m , n} \vert}^{2} \cdot {p}_{m , n}}{{σ}_{m , n}^{2}} ) & ( 6 )\end{matrix}$$

is satisfied according to expression (2). Also, If the transmission path with the best condition for the n-th subcarrier is:

$$\begin{matrix}[ Expression 9 ] & \\ {H}_{n} ≡ {max}_{1 \leq m \leq M} \vert \frac{{H}_{m , n}}{{σ}_{m , n}} \vert , & \\ [ Expression 10 ] & \\ {R}_{b} \leq {\sum }_{m = 1}^{M} {\sum }_{n = 0}^{N - 1} {f}_{b} ( {\vert {H}_{n} \vert}^{2} \cdot {p}_{m , n} ) & ( 7 )\end{matrix}$$

is satisfied. Further, the user having the transmission path with the best condition for the n-th subcarrier is expressed as below.

$$\begin{matrix}[ Expression 11 ] & \\ {m}_{n} ≡ arg {max}_{1 \leq m \leq M} \vert \frac{{H}_{m , n}}{{σ}_{m , n}} \vert & ( 8 )\end{matrix}$$

where argmax is the largest set of the function. The maximum value on the right side of expression (7) under condition (5) can be achieved even when P_{m,n}=0 while m≠mₙ is satisfied.

### Accordingly, if

$$\begin{matrix}[ Expression 12 ] & \\ {\sum }_{n = 0}^{N - 1} {f}_{b} ( {\vert {H}_{n} \vert}^{2} \cdot {p}_{{m}_{n} , n} ) & ( 9 )\end{matrix}$$

is maximized, the maximum value of the right side of expression (7) can be obtained. When p_{m,n}=0 is satisfied for m≠mₙ, the equation in expression (7) is satisfied. Thus, it is understood that the maximum value of R_{b} can be obtained by maximizing expression (9). In other words, the maximum value can be obtained by selecting, using expression (8), the user with the best condition in the n-th subcarrier, allocating the subcarrier only to that user, and thereafter performing maximization.

### (1.3) Formulation of Problem

When f_{b}(•) is a function that only results in upwardly convex positive integers, the maximization of expression (9) is aimed at under the condition that the transmission power condition is as expressed below.

$$\begin{matrix}[ Expression 13 ] & \\ {\sum }_{n = 0}^{N - 1} {p}_{{m}_{n} , n} \leq P & ( 10 )\end{matrix}$$

In embodiments of the present invention, an algorithm is used for directly obtaining the maximum value under constraining condition (5) while leaving discrete rate function (4) as a discrete value. This can be solved by using “matroid convex function”, which has developed from Graph/Network theory. Hereinafter, a method that uses a matroid convex function will be explained, but the method below is described in detail in:

“Discrete Convex Analysis” written by Kazuo Murota, published by KYORITSU SHUPPAN CO., LTD in 2001

### (2.1) Definitions for Preparation

In order to describe the theorem, definitions are presented.

D.1: Z represents a set of integers, and V≡{0, 1, . . . , N−1}. Under this condition, positive and negative supports for an N-dimensional integer vector X=(X₀, . . . , X_{N-1})εZ^{N} are defined as below.

SUPP(X)={nεV|Xₙ>0}

SUPP(X)={nεV|Xₙ<0} [Expression 14]

D.2: χₙε{0,1}^{V}, which is an N-dimensional characteristic vector (unit vector) for nεV(0≦n≦N−1) is defined as below:

$$\begin{matrix}[ Expression 15 ] & \\ {χ}_{n} ( l ) ≡ {δ}_{nl} = \{ \begin{matrix}1 & ( l = n ) \\ 0 & ( l \neq n ) ,\end{matrix} & \end{matrix}$$

where lεV(0≦l≦N−1)
where χₙ, which is an N-dimensional characteristic vector, is a unit vector in which the n-th component is 1 and other components are all zero.

D.3: The effective domain for F:Z^{N}→R∪{+∞}, where R represents a set of actual numbers and the integer grid point is the domain, is defined as below:

dom(F)≡{XεZ^{N}|F(X)<+∞} [Expression 16]

where dom represents a domain.

D.4: When F:Z^{N}→R∪{+∞} is a matroid convex function, it is defined that the interchange theorem below is satisfied.

### <Interchange Theorem of Convex Function>

νεSUPP⁻(X−Y) (in other words, a ν that satisfies X_{ν}<Y_{ν}) exists for arbitrary numbers X, Yεdom(F), and uεSUPP⁺(X−Y) (in other words, a u that satisfies Xᵤ>Yᵤ) and νεSUPP⁻(X−Y) satisfies the expression below.

F(X)+F(Y)≧F(X−χᵤ+χ_{ν})+F(Y+χᵤ−χ_{ν}) [Expression 17]

D.5: When a set of integer grid points: B⊂Z^{N} is a matroid convex set, it is defined that the interchange theorem below is satisfied.

### <Interchange Theorem of a Convex Set>

νεSUPP⁻(X−Y) (in other words, a ν satisfying X_{ν}<Y_{ν}) exists for arbitrary numbers X, YεB, and uεSUPP⁺(X−Y) (in other words, a u satisfying Xᵤ>Yᵤ) exists and satisfies the expression below.

X−χᵤ+χ_{ν}εB and Y+χᵤ−χ_{ν}εB [Expression 18]

D.6: For B⊂Z^{N}, which is a bounded matroid convex set, R(B) ⊂Z^{N} is defined as below.

$$\begin{matrix}[ Expression 19 ] & \\ R ( B ) ≡ \{ \begin{matrix}Y = ( {Y}_{0} , … , {Y}_{N - 1} ) ∈ B \vert \\ {\tilde{l}}_{B} ( v ) \leq {Y}_{n} \leq {\tilde{u}}_{B} ( v ) , 0 \leq n \leq N - 1\end{matrix} \} \\ where \\ {l}_{B} ( n ) ≡ {min}_{Y ∈ B} {Y}_{n} \\ {u}_{B} ( n ) ≡ {max}_{Y ∈ B} {Y}_{n} ( 0 \leq n \leq N - 1 ) \\ {\tilde{l}}_{B} ( n ) ≡ ⌊ ( 1 - \frac{1}{N} ) \cdot {l}_{B} ( n ) + \frac{1}{N} {u}_{B} ( n ) ⌋ : truncated to integer \\ ( 0 \leq n \leq N - 1 ) \\ {\tilde{u}}_{B} ( n ) ≡ ⌊ \frac{1}{N} {l}_{B} ( n ) + ( 1 - \frac{1}{N} ) {u}_{B} ( n ) ⌋ : rounded up to integer \\ ( 0 \leq n \leq N - 1 ) & \end{matrix}$$

In the above, it is guaranteed that R(b)≠φ is satisfied.

### (2.2) Minimization Theorem (Domain Reduction Method)

The theorem below is used as a basic theorem.

### <Minimization Theorem of Matroid Convex Function (Domain Reduction Method)>

S0 through S4 below are algorithms for obtaining the combination of the maximum bit rate according to the present invention.

F:Z^{N}→R∪{+∞} is handled as a bounded matroid convex function.
(S0) Set B so that B=dom(F)
(S1) Select arbitrary XεR(B). (R(B)≠φ is satisfied)
(S2) Minimize F(X−χᵤ+χ_{ν}), and also find u and ν that satisfy 0≦u, ν≦N−1, and u≠v
(S3) If F(X)≦(X−χᵤ+χ_{ν}) is satisfied, the process is terminated (X is the optimal solution)
(S4) Set new B so that B ∩{Y=(Y₀, . . . , Y_{N-1})εZ^{N}|Yᵤ≦Xᵤ−1, Y_{ν}≧X_{ν}+1}, and return to (S1)
Because dom (F) is bounded, the magnitude is expressed by the expression below.

K=max{∥X−Y∥_{∞}|X,Yεdom(F)} [Expression 20]

The result of this algorithm can be obtained within a calculation time of polynomial order for log₂K and N.

### (2.3) Proof of Applicability of Minimization Theorem

Here, it will be explained how the results obtained in the above operation satisfy the conditions of the above minimization theorem.

As was described using expression (8), mₙ (1≦mₙ≦M) is determined for arbitrary n (0≦n≦N−1), and accordingly the maximization of transmission power p_{m,n} is considered under constraining condition (10). When considering optimization, generality is not lost even when the unit value of transmission power is p_{m,n}εZ^{+≡}{0, 1, 2, . . . }, which is a non-negative and sufficiently high value of integer. Usually, transmission power is expressed in a form of successive values; however, in actuality, unit values in increases and decreases in transmission power are used for controlling transmission power. Accordingly, transmission power as well can be thought to be a discrete value. In such a case, the difference between directly using a value of the transmission power or using an integer as described above is only the amount of a constant multiple of a variable of transmission power in a rate function. Thus, either one can be used as long as a constant for the constant multiplying is used appropriately.

F:Z^{N}→R∪{+∞}, a matroid convex function, is defined as described below.

For arbitrary X=(X₀, . . . , X_{N-1})εZ^{N} and (XₙεZ, 0≦n≦N−1) it is assumed that X=(X₀, . . . , X_{N-1})=(p_{m0,0}, . . . , P_{mN-1,N-1}), the domain is constraining condition (10), and F (X) is a negative bit rate sum, as expressed by the expression below.

$$\begin{matrix}[ Expression 21 ] & \\ F ( X ) ≡ \{ \begin{matrix}- {\sum }_{n = 0}^{N - 1} {f}_{b} ( {\vert {H}_{n} \vert}^{2} {X}_{n} ) ; & when {\sum }_{n = 0}^{N - 1} {X}_{n} \leq P and {X}_{n} \geq 0 \\ 0 & otherwise\end{matrix} & \end{matrix}$$

As was described above, expression (9) is an upwardly convex function, and accordingly (X), to which a minus sign (−) is added, is a downwardly convex function. Also, the maximum value problem can be addressed instead of the minimum value problem. Further, because f_{b} () is bounded, F(X) is also bounded. The constraining condition set below

$$\begin{matrix}[ Expression 22 ] & \\ \{ X = ( {X}_{0} , … , {X}_{N - 1} ) ∈ {Z}^{N} \vert {\sum }_{n = 0}^{N - 1} {X}_{n} \leq P , {X}_{n} \geq 0 \} & \end{matrix}$$

is a bounded convex set, and accordingly it is also a bounded matroid convex set. Accordingly, F(X) is also a bounded convex matroid function. Thus, the conditions of <Minimization theorem> are satisfied, and the applying of this algorithm can realize the maximization of bit rates.

“Water-filling algorithm”, a conventional algorithm, is for obtaining an optimal value of successive functions, and accordingly this algorithm is for obtaining an approximate value when the optimal value of a discretion function is to be obtained. However, a “minimization algorithm of a matroid convex function” according to the present embodiment is a method by which the optimal value of a discrete function is obtained in a manner that is theoretically proven, and thus is an algorithm that can realize true theoretical maximization of bit rates. The bit rates to be selected are all integers, as described below.

### BPSK=1 bit

QPSK=2 bits
8-QAM=3 bits
16-QAM=4 bits
64-QAM=5 bits

Accordingly, the difference between the maximum bit rate of a system based on an approximate value and the maximum bit rate of a system base on a true value is relatively large. For example, when “QPSK=2 bits” is selected on the basis of approximation by a conventional method while a modulation method for achieving true maximization is “8-QAM=3 bits” for all users, a bit rate 1.5 times higher can be obtained. The worse the noise situation in a radio section is, the more effective the present embodiment is.

A “minimization algorithm of matroid convex function” is complicated, but can be finished within a period of time taken for as many polynomials as there are subcarriers, and if N is a relatively high value (such as 2000), the time difference between this method and the “water-filling algorithm” is not so large.

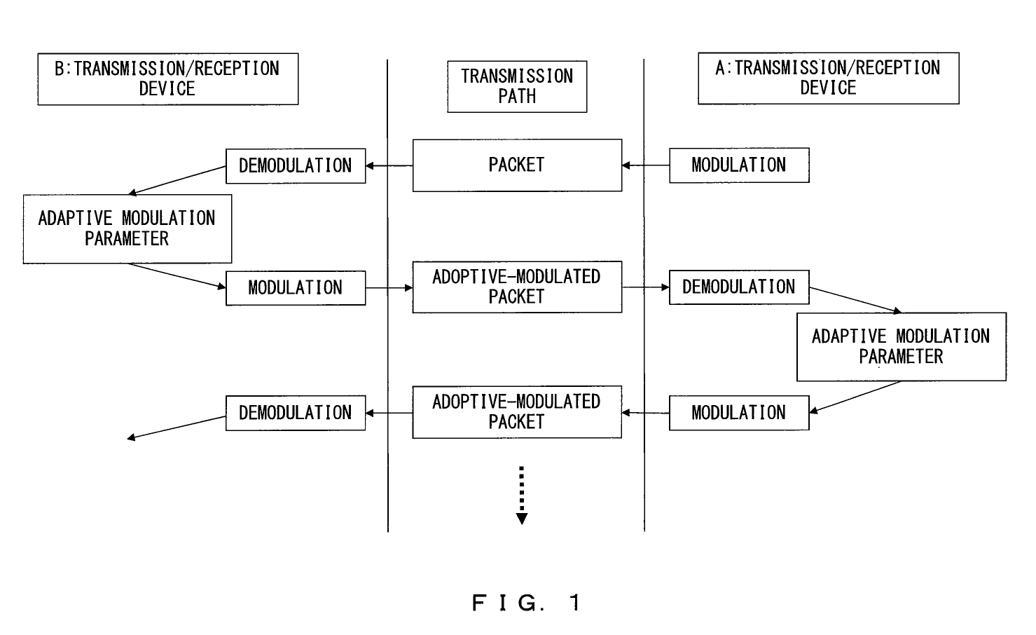

FIG. 1 is a conceptual view illustrating OFDM communication.

Transmission/reception device A transmits, to transmission/reception device B, packet data modulated in accordance with OFDM signals. Transmission/reception device B demodulates the packet data in accordance with a specified modulation method. In doing this, the transmission/reception device B side can recognize the transmission path state of each subcarrier. Thus, by using an algorithm in the present embodiment, a modulation method presenting higher bit rate (such as “64-QAM=5 bits) is assigned to subcarriers with a good CINR and a modulation method presenting lower bit rate (such as BPSK=1 bit) is assigned to subcarriers with a poor CINR, and data is transmitted to the transmission/reception device A side. Transmission/reception device A demodulates packet data in accordance with a specified modulation method. Because the transmission/reception device A side can also recognize the transmission path state of each subcarrier, it uses an algorithm in the present embodiment in order to assign a modulation method presenting a high bit rate to subcarriers with a good CINR and a modulation method presenting lower bit rate to subcarriers with a poor CINR, and modulates data so as to transmit the data to the transmission/reception device B side. This process is repeated. Herein, it is assumed that states of transmission paths are assumed to be the same between the direction from transmission/reception device A to transmission/reception device B and the direction from transmission/reception device B to transmission/reception device A.

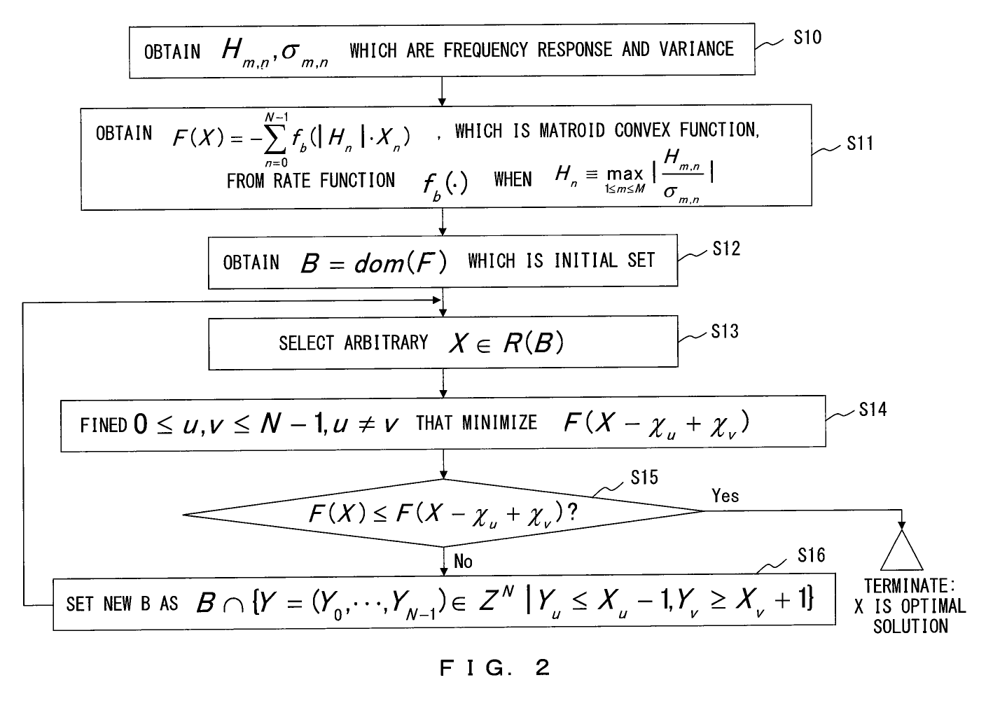

FIG. 2 illustrates a flowchart for an optimal bit rate calculation algorithm according to an embodiment of the present invention.

First, in step S10, frequency response H_{m,n} and variance σ_{m,n} are obtained from a reception signal. In step S11, a matroid convex function as expressed below is obtained from f(•).

$$\begin{matrix}[ Expression 23 ] & \\ F ( X ) = - {\sum }_{n = 0}^{N - 1} {f}_{b} ( {\vert {H}_{n} \vert}^{2} \cdot {X}_{n} ) & \end{matrix}$$

However, the expression below is satisfied.

$$\begin{matrix}[ Expression 24 ] & \\ {H}_{n} ≡ {max}_{1 \leq m \leq M} \vert \frac{{H}_{m , n}}{{σ}_{m , n}} \vert & \end{matrix}$$

Next, in step S12, an initial set B=dom(F) is obtained. In step S12, an arbitrary XεR(B) (R(B) is as defined above) is selected. This selection can be made in a completely arbitrary manner. Next, in step S14, a u and ν are found which minimize F (X−χᵤ+χ_{ν}) and satisfy 0≦u, ν≦N−1, and u≠v. In this case, every pair of u and ν that satisfies this condition is selected and substituted into F(X−χᵤ+χ_{ν}) one at a time, and the pair that results in the smallest value is obtained. In step S15, it is determined whether or not F(X)≦F(X−χᵤ+χ_{ν}) is satisfied. When the determination result in step s15 is No, a new B is set as below.

B∩{Y=(Y₀, . . . , Y_{N-1})εZ^{N}|Xᵤ−1,Y_{ν}≧X_{ν}+1} [Expression 25]

Thereafter, the process returns to step S13. When the determination result in step s15 is Yes, x is considered to be the optimal solution, and the process is terminated.

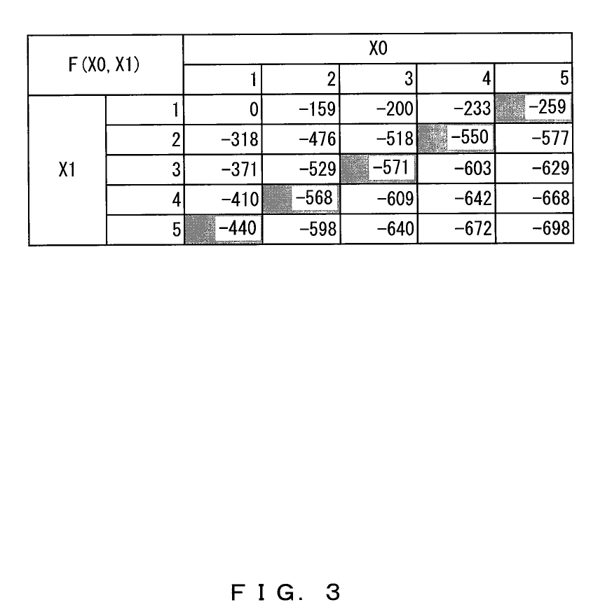

FIG. 3 illustrates effects of embodiments of the present invention.

For simplicity, it is assumed that the number of subcarriers is 2 (N=2), the number of users is 2 (M=2), and the maximum transmission power is 6 (P=6). Also, the frequency response and variance are set as below.

H_{0,0}=1, H_{0,1}=1, H_{1,0}=2, H_{1,1}=2,

σ_{0,0}=1, σ_{0,1}=1, σ_{1,0}=1, σ_{1,1}=1,

Accordingly, H₀=1 and H₁=2 are satisfied.

It is assumed that the rate function is f(x)=100·log₂(1+x), which is a constant multiple of the theoretically maximum value. The discrete function is set as below.

f_{b}(x)=┌100·log₂(1+x)┐ [Expression 26]

where ┌y┐ is integer not exceeding y

When the above expression is satisfied,

F(X₀,X₁)=−┌100·log₂(1+X₀)┐−┌100·log₂(1+4·X₁)┐ [Expression 27]

is satisfied. The discrete function satisfies X₀+X₁≦P=6 and also makes F (X₀, X₁) result in the minimum value when F(3,3)=−571 is satisfied when X₀=3 and X₁=3. However, in the case of a maximum value calculation based on conventional successive function approximation, the maximum value has been shifted to the side of the second variable X₁ of F, and accordingly, X₀=2 and X₁=4 are satisfied. As in this case, a method using conventional successive function approximation is used, and the sum of bit rates are not always maximum.

The general expression of F(X) for using the above rate function is given as below.

$$\begin{matrix}[ Expression 28 ] \\ F ( X ) = - {\sum }_{n = 0}^{N - 1} ⌈ 100 \cdot {log}_{2} ( 1 + {\vert {H}_{n} \vert}^{2} \cdot {X}_{n} ) ⌉\end{matrix}$$

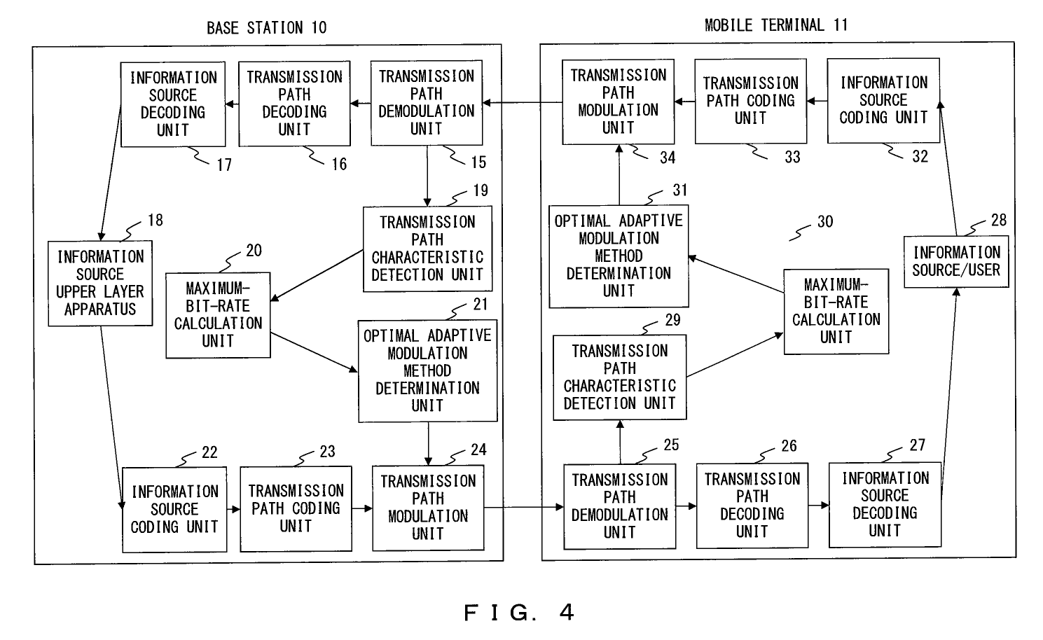

FIG. 4 is a block diagram illustrating a transmission/reception device according to embodiments of the present invention.

As illustrated in FIG. 4, in an OFDM wireless communications system, a base station 10 communicates with a mobile terminal 11, and each of them is provided with a transmission/reception device of the present embodiment. The blocks of the base station 10 and the mobile terminal 11 illustrated in FIG. 4 respectively illustrate the configurations of the transmission/reception devices. In the base station 10, signals from the mobile terminal 11 are received, and signals demodulated by a transmission path demodulation unit 15 for demodulating signals are transferred to a transmission path decoding unit 16 so as to be decoded. The transmission path decoding includes demodulating of error correction codes and the like. The transmission path demodulation unit 15 supplies, to a transmission path characteristic detection unit 19, information on conditions of radio circuits. Information included in signals decoded by the transmission path decoding unit 16 is decoded by an information source decoding unit 17, and those signals are given to an information source. The information source demodulation includes demodulating of compressed images and compressed audio. An information source 18 is connected to a radio device on a higher layer. Information from the information source 18 is coded by an information source coding unit 22. Next, the information is coded by a transmission path coding unit 23 so as to be output to a transmission path. The coding of information includes compression of audio data, image data, and the like. The transmission path coding includes error correction coding and the like. Signals that have been transmission-path coded are transmitted to a transmission path modulation unit 24. The transmission path modulation unit 24 sets BPSK or QPSK as a modulation method in accordance with instructions from an optimal adaptive modulation method determination unit 21 in order to modulate signals.

The optimal adaptive modulation method determination unit 21 determines the most appropriate modulation method on the basis of the calculation results obtained from a maximum bit-rate calculation unit 20. The maximum bit-rate calculation unit 20 uses a calculation method according to the above described present embodiment on the basis of the information on the variance and frequency response obtained from the transmission path characteristic detection unit 19 so that it can calculate the combination of transmission power values allocated to the respective subcarriers that results in the maximum bit rate. When the combination of transmission power values is determined, a rate function determines bit rates to be allocated to the respective subchannels. This calculation result is supplied to the optimal adaptive modulation method determination unit 21. The optimal adaptive modulation method determination unit 21 determines a modulation method on the basis of the bit rate allocated to each subcarrier. The transmission path modulation unit 24 transmits signals using the determined bit rate and transmission power value.

The transmission/reception device in the mobile terminal 11 is essentially the same in configuration as the counterpart in the base station 10. Specifically, in the mobile terminal 11, signals from the base station 10 are received, and signals demodulated by a transmission path demodulation unit 25 are transmitted to a transmission path decoding unit 26 so as to be decoded. The transmission path decoding includes demodulating of error correction codes and the like. The transmission path demodulation unit 25 supplies, to a transmission path characteristic detection unit 29, information on the conditions of radio circuits. Information in signals decoded by the transmission path decoding unit 26 is decoded by an information source decoding unit 27, and those signals are given to an information source/user 28. The received images and audio are presented to users. The information source demodulation includes demodulation of compressed images and compressed audio. Information from the information source/user 28 is coded by an information source coding unit 32. Next, the information is coded by a transmission path coding unit 33 so as to be output to a transmission path. The coding of information includes compression of audio data, image data, and the like. The transmission path coding includes error correction coding and the like. Signals that have been transmission-path coded are transmitted to a transmission path modulation unit 34. The transmission path modulation unit 34 sets BPSK or QPSK as a modulation method in accordance with instructions from an optimal adaptive modulation method determination unit 31 in order to modulate signals.

The optimal adaptive modulation method determination unit 31 determines the optimal modulation method on the basis of a computation result obtained from a maximum bit-rate calculation unit 30. The maximum bit-rate calculation unit 30 uses a calculation method according to the above described present embodiment on the basis of the information on the variance and frequency response obtained from the transmission path characteristic detection unit 29 so that it can calculate the combination of transmission power values allocated to the respective subcarriers that results in the maximum bit rate. When the combination of transmission power values is determined, a rate function determines bit rates to be allocated to the respective subchannels. This calculation result is supplied to the optimal adaptive modulation method determination unit 31. The optimal adaptive modulation method determination unit 31 determines a modulation method on the basis of the bit rate allocated to each subcarrier. The transmission path modulation unit 24 transmits signals using the determined bit rate and transmission power value.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present invention has (have) been described in detail, it should be understood that the various changes, substitutions, and alterations could be made hereto without departing from the spirit and scope of the invention.

What is claimed is:

1. A transmission and reception device that is for a communications system using a plurality of subcarriers and that is able to set transmission power and a modulation method for each of the subcarriers, comprising:
a transmission path characteristic extraction unit to extract a transmission path characteristic from a received signal;
a maximum bit-rate determination unit to determine a transmission power value and a transmission bit rate of each subcarrier by using a minimization algorithm of a discrete function for minimizing a matroid convex function expressing a relationship between a discrete transmission power value and a bit rate, on the basis of a transmission path characteristic so that a bit rate of an entire transmission is maximized; and
a transmission unit to transmit a signal by using a modulation method corresponding to the determined transmission power value and the determined transmission bit rate.

2. The transmission and reception device according to claim 1, wherein:
the transmission path characteristic is a frequency response of each subcarrier and a variance of noise distribution in each subcarrier.

3. The transmission and reception device according to claim 2, wherein:
the minimization algorithm obtains X, which satisfies
F(X)≦(X−χᵤ+χ_{ν})
where u and ν are integers satisfying 0≦u, ν≦N−1, and u≠ν, when it is assumed that X is an N-dimensional vector, components of which are values that transmission power values of N (N is a natural number) subcarriers can be, that an N-dimensional characteristic vector, an n-th component of which is 1 and other components of which are 0, is χₙ, and that a matroid convex function expressing a negative number of a total value of transmission bit rates of all subcarriers with respect to X is F(X).

4. The transmission and reception device according to claim 3, wherein:
when
$$\begin{matrix}[ Expression 29 ] \\ {H}_{n} ≡ {max}_{1 \leq m \leq M} \vert \frac{{H}_{m , n}}{{σ}_{m , n}} \vert\end{matrix}$$
is satisfied where Xₙ represents a component of an N-dimensional vector X, H_{m,n} is a frequency response of a signal to an n-th user of an m-th subcarrier, and σ_{m,n} represents a variance of noise distribution of a signal of an n-th user of an m-th subcarrier, then
F(X) is obtained by
$$\begin{matrix}[ Expression 30 ] \\ F ( X ) = - {\sum }_{n = 0}^{N - 1} ⌈ 100 \cdot {log}_{2} ( 1 + {\vert {H}_{n} \vert}^{2} \cdot {X}_{n} ) ⌉\end{matrix}$$
Where ┌y┐ is integer not exceeding y.

5. The transmission and reception device according to claim 1, wherein:
the transmission and reception device is included in the base station or the mobile terminal of the communications system.
